(19) United States
(12) Patent Application Publication
(10) Pub. No.: US 2015/0069295 A1
(43) Pub. Date: Mar. 12, 2015

(54) HYDROGEL NANOCOMPOSITE

(71) Applicant: National University of Singapore, Singapore (SG)

(72) Inventors: Ghim Wei Ho, Singapore (SG); Minmin Gao, Singapore (SG); Jing Wang, Singapore (SG)

(21) Appl. No.: 14/481,608

(22) Filed: Sep. 9, 2014

Related U.S. Application Data
(60) Provisional application No. 61/875,196, filed on Sep. 9, 2013.

(51) Int. Cl. C01B 3/00; B01J 23/52; H01G 4/04; H01M 8/04; H01G 9/20; C01B 3/08; B01J 21/18

(52) U.S. Cl. CPC C01B 3/0021; C01B 3/08; B01J 23/52; B01J 21/185; H01M 8/04216; H01G 9/20; H01G 4/04
USPC 252/188.25

(57) ABSTRACT

A hydrogel composition for photocatalytic hydrogen production and storage. The composition containing a graphene, a TiO₂ nanotube array, and a carbon quantum dot defines a three-dimensional porous and continuous cross-linked structure. Also disclosed is a method of producing this composition.

### CROSS-REFERENCE TO RELATED APPLICATIONS

The present application claims the benefit of U.S. Provisional Patent Application Ser. No. 61/875,196, which was filed on Sep. 9, 2013, and is hereby incorporated by reference.

### BACKGROUND OF THE INVENTION

1. Field of the Invention

This invention relates to a hydrogel nanocomposite. In particular, the invention relates to a hydrogen nanocomposite capable of photocatalytic hydrogen production and storage.

2. Background Information

There is an increasing demand for energy and growing environmental concerns that drive the search for new renewable sources of energy to replace the fast depleting fossil fuel energy sources.

The common method to recover hydrogen from water is to pass electric current through water and thus to reverse the oxygen-hydrogen reaction, i.e. in water electrolysis. Another method involves extraction of hydrogen from fossil fuels, for example from natural gas or methanol. This method is complex and usually results in residues, such as carbon dioxide, at best. And there is only so much fossil fuel available. In these reforming methods, the resulting hydrogen must be somehow stored and delivered to the user, unless the hydrogen generation is performed close to the consumption system. Performing a safe, reliable, and low-cost hydrogen storage and delivery is currently one of the challenges of the hydrogen-based economy. Potentially, a relatively large amount of energy can be released when the two elements of water (oxygen and hydrogen) react to form water. This energy may be captured and efficiently converted to electricity in fuel cells. More importantly, nothing else is released when oxygen and hydrogen react to form water. Consequently, the hydrogen-oxygen reaction is potentially a pollution-free source of energy.

Since one possible way to store large amounts of energy is in the form of a chemical energy carrier, hydrogen is considered as one of the primary candidates for future energy storage. The future prospect of hydrogen economy is mainly in the direct conversion of solar energy into hydrogen by means of, for example, photoelectrochemical devices for water splitting.

The overall efficiency of such a device would be determined by the basic working principles and properties of photoactive materials. The tremendous progress made in the field of nanostructured materials provides new exciting opportunities for water splitting. In such devices, when the semiconductor material is illuminated with photons of energy larger than the bandgap, electrons are excited from the valence band into the conduction band. The excited electrons travel to the back contact and are transported to the counter electrode where they reduce water and form hydrogen gas. The holes that remain in the valence band migrate to the surface, where they oxidize water and form oxygen gas. The recombination of electrons and holes is prevented by an applied bias and by electric field appearing during the formation of a Schottky-type contact between the semiconductor material and the aqueous electrolyte (shown by a “bending” of the energy bands).

Photoelectric materials for efficient hydrogen generation have to meet the following requirements: (1) strong UV/visible light absorption; (2) high chemical stability in the dark and under illumination; (3) suitable band edge alignment to enable reduction/oxidation of water; (4) efficient charge transport in the semiconductor; and (5) low over potentials for the reduction/oxidation reactions.

Despite the extensive research effort, there has been no ideal photoactive material that has yet been found to meet all these requirements.

Photon upconversion luminescence is a nonlinear photophysical process characterized by the conversion of long-wavelength radiation to short-wavelength radiation. The large anti-Stokes shift between excitation and emission wavelengths is based on the sequential absorption of two or more low energy pump photons by metastable, long-living energy states followed by the emission of one higher energy photon.

The upconversion phenomenon has been observed in transition metals, actinides, but mainly in the rare earth elements, which contain the lanthanide series, yttrium, and scandium. Ln³⁺ ions have special 4f 5d inner shell configurations that are well-shielded by outer shells and have abundant and unique energy level structures. These Ln³⁺ ions can exhibit luminescence emissions via intra-4f or 4f-5d transitions. Their luminescence properties have been widely applied in lasers, photovoltaic, analytical sensors, optical imaging & displays, photocatalyst and so on. At present, the chemically instability, inefficient absorption, low luminescence output are the main limiting factors.

Gel is considered to be substance that consists of a solid scaffold with long chain molecules that cross-link to form interconnected network which encloses a continuous liquid phase (water in the case of hydrogel). Hydrogels made of natural and synthetic polymers are mainly used for biomedical applications which include drug delivery and tissue engineering whilst hydrogels consisting of TiO₂ nanofiber and nanoparticle composites are used mainly for lead, dye and wastewater treatment applications.

A hydrogel is a network of polymer chains that are hydrophilic, sometimes found as a colloidal gel in which water is the dispersion medium. Hydrogels are highly absorbent natural or synthetic polymers—they can contain over 99.9% water. Hydrogels also possess a degree of flexibility very similar to natural tissue due to their significant water content and are used in a multitude of applications, such as disposable diapers, contact lenses, EEG and ECG medical electrodes, and water gel explosives.

Graphene an important form of carbon allotrope, is gaining prevalence because of the industrial scalability, low cost (solution processable) and ease of hybridizing with other materials. Other benefits include visible light absorption, light weight, high specific surface area and outstanding chemical/electrical stability characteristics which are advantageous for catalysis applications. Due to its myriad of benefits, composites of two-dimensional (2D) assemblies of graphene sheets with metal oxide and metal nanostructures have been explored. However, to meet the demands of catalysis requirements of possessing a high surface area, porous structure and superior electrical conductivity, it is desirable to assemble the composite into a 3D framework. Forming a 3D interconnected framework (hydrogel) forms (i) desirable pores which facilitate liquid/gas access and diffusion, (ii) superior charge generation and collection of interconnected electrical pathways and (iii) conceptually ideal open structure for integration with other functional nanomaterials. Moreover, the size reduction of a photocatalyst to the nanoscale is often carried out to increase the reactive surface area, which brings about the difficulty in recovery after the catalysis process. However, constructing a catalyst into a 3D hydrogel allows ease of separation and recovery which would otherwise require extensive and expensive nanofiltration.

To date, no report has focused on the preparation and functionality of NGHs, 3D macroscopic assembled graphene sheets consisting of a photostable TiO₂ and Au nanostructure for photocatalytic H₂ production.

### SUMMARY OF THE INVENTION

In accordance with a first aspect of the present invention, there is provided a method for producing a hydrogel composition for photocatalytic hydrogen production and storage, the method comprising (a) providing TiO₂ nanorods and loading carbon quantum dots onto the TiO₂ nanorods to form a first mixture; (b) providing a second mixture of dispersed graphene oxide; (c) mixing the first and second mixture by ultrasonic dispersion to form a third mixture; and (d) adding a reducing agent to the third mixture to form the hydrogel composition that defines a three-dimensional porous and continuous cross-linked structure.

Preferably, the carbon dots are chemically coupled onto the surface of TiO₂.

Preferably, the reducing agent is vitamin C (VC). By “VC”, it is meant to include any ascorbate, ascorbic acid etc. that is typically used to refer to vitamin C. In addition to, or alternatively, the reducing agent may be, any compound with the formula C₆H₁₂O₆. For example, this compound may include any carbohydrate such as glucose or allose, or the like. More preferably, the 0.25 g of vitamin C may be added to the mixture for reducing. The reducing reaction may be a hydrothermal reaction.

Preferably, the dispersed graphene oxide is prepared by a modified Hummers method. The solvent for dispersing the graphene oxide may be any one selected from the group: ethanol, isopropyl alcohol, and dimethylformamide.

Preferably, a metal nanoparticle is added to the first mixture. More preferably, such metal nanoparticle may be any one selected from the group: gold, platinum, rhodium, palladium and any noble metal. In the case where gold is selected, its size present in the mixture and composition is 10 nm.

Preferably, the carbon quantum dots (or quantum-sized carbon dots) are prepared from ammonium bicarbonate and sodium citrate.

Preferably, the reducing step in the above step (d) is carried out at 90° C. for 90 to 240 minutes.

Preferably, the TiO₂ is in anatase powder form. The TiO₂ nanorods may be prepared by mixing TiO₂ anatase powder with NaOH and stirring the mixture for 1 hour followed by heating the mixture at 110° C. for 48 hours to form a precipitate. The precipitate is then mixed with HCl, stirred for 24 hours and rinsed dried. As an alternative to sodium hydroxide, potassium hydroxide may also be used.

The diagram below summarises the preparation steps.

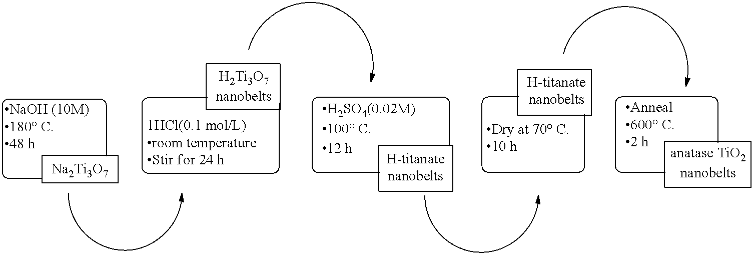

Preferably, any suitable purification and/or separation method may be carried out to obtain a reduced graphite oxide (GO) with desired characteristics.

In accordance with a second aspect of the present invention, there is provided a hydrogel composition for photocatalytic hydrogen production and storage, the composition comprising (a) a graphene; (b) a TiO₂ nanotube array; and (c) a carbon quantum dot, wherein the hydrogel composition defines a three-dimensional porous and continuous cross-linked structure. Preferably, the carbon dot is prepared by the decomposition of vitamin C.

Advantageously, and apart from obtaining a three-dimensional porous hydrogel composition, the carbon dots of the present invention are derived from alternate green carbon source (e.g. VC) instead of graphitic precursor. Such green carbon source is an inexpensive precursor and could easily be realised by a one-pot hydrothermal synthesis. Rather than physical blending or loading, the carbon dots were chemically coupled onto the TiO₂ surfaces, since vitamin C can bind with TiO₂ to form bidentate complex. Also, advantageously, the composition and method utilises the simultaneous in situ transformation of carbon dots and chemical coupling that results in the formation of efficient TiO₂/carbon dots heterostructured photocatalyst. The as-obtained nanocomposites show favorable electron transfer ability and stability during the water splitting process. Carbon dots were bonded with versatile TiO₂ nanostructures at different dimensions, including the 0D nanoparticles and 1D nanowires and we compared the photoactivities of the different heterostructures and studied their photoresponse under no potential bias condition. The present invention also uses VCs as the chemical linker and reducing agent for the 3D framework hydro gel. This allows for better control over surface area and porosity of the hydrogel and hence, the structural characteristics of the 3D framework of the hydrogel. The graphene photosensitisation and electron charge transfer and carbon dots for harvesting long wavelength light contribute to the production of a hydrogel composition that is capable of producing and storing hydrogen with excellent and surprising performances.

Preferably, the amounts of graphene, TiO₂, and carbon quantum dot present in the composition are 2 mg, 30 mg and 0.66 mg respectively.

Preferably, the hydrogel composition comprises a metal nanoparticle selected from the group: gold, platinum, rhodium, palladium and any noble metal. If gold is selected, the gold nanoparticle is 10 nm in size.

Preferably, the surface of the graphene is modified. Such modification may be any suitable chemical or mechanical method of modification known to the skilled person. From chemical analysis carried out on the present hydrogel composition, it shows the presence of various carbon bonds namely C—C (284.6 eV), C—O (286.5 eV), and C═O (288.1 eV), corresponding to sp² aromatic rings, epoxy/alkoxy, and carbonyl groups, respectively.

Preferably, the surface area of the graphene is about 400 m²/g.

Preferably, the porosity of the hydrogel is about 1.9 cm³/g. Preferably, the pores have a bimodal size distributions of 3.9 and 24 nm.

In accordance with a third aspect of the present invention, there is provided an electrode, capacitor, fuel cell, solar cell, sensor, battery comprising a hydrogel composition according to the second aspect of the invention.

The present invention relates to the development of a nanocomposite graphene hydrogel (NGH) based on green chemistry, employing vitamin C (VC) to attain a supramolecular 3D network of hybrid nanostructured materials. Advantageous, it is shown that the hydrogel is an appropriate and robust host for stable a TiO₂ semiconductor catalyst sensitized with visible light responsive nanostructured particles. The NGH is tailored with well-defined nano-mesopores, a large surface area, a highly dispersive nanosheet-nanorods-nanoparticle composite, and enhance visible light absorption. The present invention also demonstrates the practical applications of utilizing the NGH with water containing pores for photocatalytic H₂ production. An important pragmatic consideration of using a NGH is the ease of separation and recovery of the nanosized catalyst after the photoreaction which would otherwise require extensive and expensive nanofiltration. The TiO₂ may be recovered by a suitable microfiltration method.

Advantageously, the hydrogel composite forms a three-dimensional porous and continuous cross-linked structure network that functionalizes and sensitizes with the semiconductor photocatalyst, carbon quantum dots and co-catalyst nanoparticles to enable upconversion UV-Vis-NIR light absorption (as opposed to UV light) for photocatalytic H₂ production based on complete solution process.

Carbon quantum dots upconverter has the important characteristics of enhanced photon absorption as it enables photon absorption of light with energy below the bandgap or tap on a large fraction of the visible and near infra red by upconversion.

Metal nanoparticles co-catalyst can also be loaded onto hydrogel composite to obtain a high activity and reaction rates. The co-catalyst improves the efficiency of H₂ production, as a result of effective (i) capturing of electrons and holes, thereby reducing the possibility of electron-hole recombination; (ii) transferring of electrons and holes to water molecules surface, thereby reducing the activation energy for the reduction/oxidation of water; and (iii) serving as active sites for gas evolution on the photocatalyst surface.

Furthermore, 3D graphene hydrogel has been proven to uptake large quantity of water (96-98%) which is used directly for water splitting. The evolved H₂ molecules are adsorbed-trapped in the hydrogel framework which can be release upon mechanical agitation at room temperature and pressure.

Another key benefit is the “green” synthesis method which employs VC, reducing agent to physically and chemically cross-linked graphene sheets. The environmentally friendly and solution based approach means that fabrication on an industrial scale will be feasible, which can potentially lead to much cheaper materials.

The present invention utilizes a NGH-based on green chemistry, employing VC to attain a supramolecular 3D network of hybrid nanostructured materials. The NGH possesses novel physicochemical properties, well-defined nano-mesopores, a large surface area, a highly dispersive composite, and enhanced visible light absorption characteristics. Next, practical applications by utilizing the NGH with water containing pores for water splitting to produce and possibly uptake H₂ will also be described.

### BRIEF DESCRIPTION OF THE DRAWINGS

The invention description below refers to the accompanying drawings, of which:

FIG. 1 is a schematic representation of the synthetic procedures for synthesizing the NGH and NGH-Au according to an embodiment of the present invention;

FIG. 2 (a-b) Time-evolution studies of NGH and NGH-Au with VC respectively. (c) NGH consists of pores that absorb water to form a gel-phase which remains stable upon inversion of the vial containing gel. SEM images of the supercritically dried (d) GH and (e) NGH. The pore sizes are in the sub to several micrometers range while the pore walls are thin/semi-transparent;

FIG. 3 (a) Type IV nitrogen adsorption/desorption isotherms which indicates that the NGH is mesoporous. (b) BJH pore size distribution with corresponding bimodal pore diameters of 3.9 and 24 nm. XPS spectra of deconvoluted C1s of (c) GO (d) GH and (e) NGH. The inset of 3d shows the chemical structure of VC. (f) Ti2p XPS spectrum of NGH;

FIG. 4 (a) Raman spectra of GO, GH, and NGH which display two characteristics peaks around 1350 and 1590 cm, attributed to the D and G bands of carbon, respectively. (b) XRD spectra of GO, GH, and NGH. The interlayer spacings of GO and GH are 8.5 Å and 3.8 Å respectively. (c-d) TEM images of TiO2 nanorods homogeneously dispersed onto the graphene sheets. (e) High resolution TEM images show that the NGH is composed of 3 to 6 layers of graphene sheets which are well-interfaced with anatase phase TiO₂ nanorods;

FIG. 5 (a-b) TEM images of NGH-Au. The Au nanoparticles (darker contrast) are fairly uniformly deposited on the TiO₂ nanorods. (c) High resolution TEM image shows lattice fringes of the Au nanoparticles, well matched to the (111) planes of Au. (d) Size distribution of Au nanoparticles 2.5-15 nm, mean diameter of 10 nm. (e) XRD spectra of GH, NGH and NGH-Au. (f) Absorption spectra of TiO₂ nanorods, Au nanoparticle loaded TiO₂ nanorods and NGH-Au samples in the range of 200-800 nm;

FIG. 6 shows photocatalytic H₂ production studies of the various samples. (a) H₂ production of the control samples (pure TiO2 nanorods and 2D RGO-TiO₂ composite) and NGH with different wt % loading of Au nanoparticles under different light wavelength irradiations. (b) Proposed photocatalytic mechanism of the NGH-Au under ultraviolet and visible light irradiation;

FIG. 7 shows photocatalytic H₂ production studies of the various samples. (a) H₂ production of the control samples (pure TiO₂ nanorods and 2D RGO-TiO2 composite) and NGH with different wt % loading of Au nanoparticles under different light wavelength irradiations. (b) Proposed photocatalytic mechanism of the NGH-Au under ultraviolet and visible light irradiation;

FIG. 8 shows H₂ generated and entrapped at room temperature and pressure as measured by gas chromatography;

FIG. 9 shows pressure-composition H₂ isotherm of hydrogel composite at room temperature and pressure range of 0 to 100 atm;

FIG. 10 shows H₂ adsorption in pure TiO₂, 2D RGO-TiO₂ and NGH;

FIG. 11 shows Pressure-composition H₂ isotherm of NGH at room temperature and pressure range of 0 to 100 atm; and

FIG. 12 shows H₂ measurements after light irradiation, sonification and light irradiation (2 h) with sonification of NGH.

### DETAILED DESCRIPTION OF AN ILLUSTRATIVE EMBODIMENT

All publications and patent applications herein are incorporated by reference to the same extent as if each individual publication or patent application was specifically and individually indicated to be incorporated by reference.

The following description includes information that may be useful in understanding the present invention. It is not an admission that any of the information provided herein is prior art or relevant to the presently claimed inventions, or that any publication specifically or implicitly referenced is prior art.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are described.

### Synthesis of the Nanocomposite Hydrogel (NHG)

0.34 g of TiO₂ anatase powder was mixed with an amount of 10 M of aqueous NaOH. The mixture was stirred for 1 h to get a homogenous mixture before it was transferred to a Teflon-lined stainless steel autoclave and heated in an oven at 110° C. for 48 h. The precipitate was then mixed with 20 ml of 1M of HCl, stirred for 24 h and finally rinsed dried to form TiO₂ nanorods.

Then 4.2 mM of HAuCl₄, 0.42 M of urea and 0.1 g of TiO₂ nanorods were added into 10 ml DI water and stirred for 2 h at 80° C. water bath. The mixture was then calcinated at 300° C. for 4 h to obtain TiO₂ nanorods-Au nanoparticles.

Carbon dots derived from ammonium bicarbonate and sodium citrate are loaded onto TiO₂ nanorods by hydrothermal method 60° C. for 2 hours. Subsequently, 0.25 g of VC was added into 10 ml Graphite oxide (GO) (produced by modified Hummers method) aqueous dispersion (0.2 mg/ml) and 30 mg of TiO₂ nanorods/TiO₂ loaded Au nanoparticles and heated to 90° C. for 1.5 to 4 hr to obtain NGH and NGH-Au respectively. 2D RGO TiO₂ is prepared based on the same procedure without the addition of Au nanoparticles and VC (which is essential for formation of 3D hydrogel).

During the reduction reaction, titanium ions can form charge-transfer complexes with oxygen atom from ligands, leading to the bidentate binding between TiO₂ and VC.

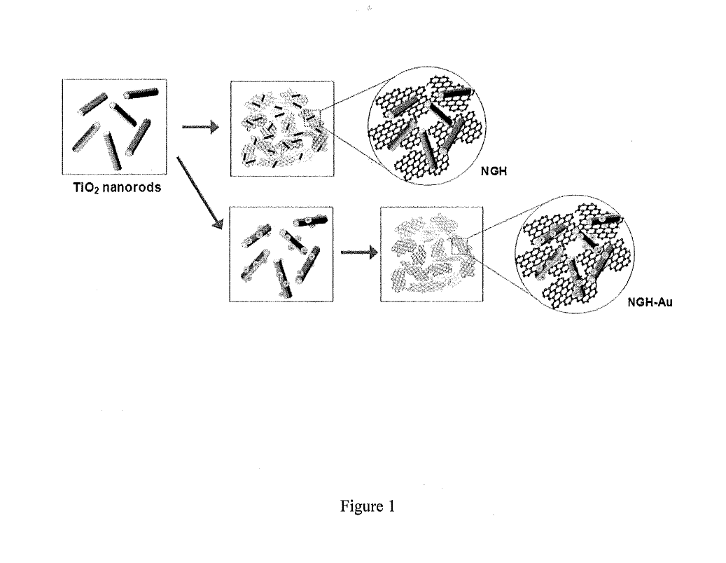

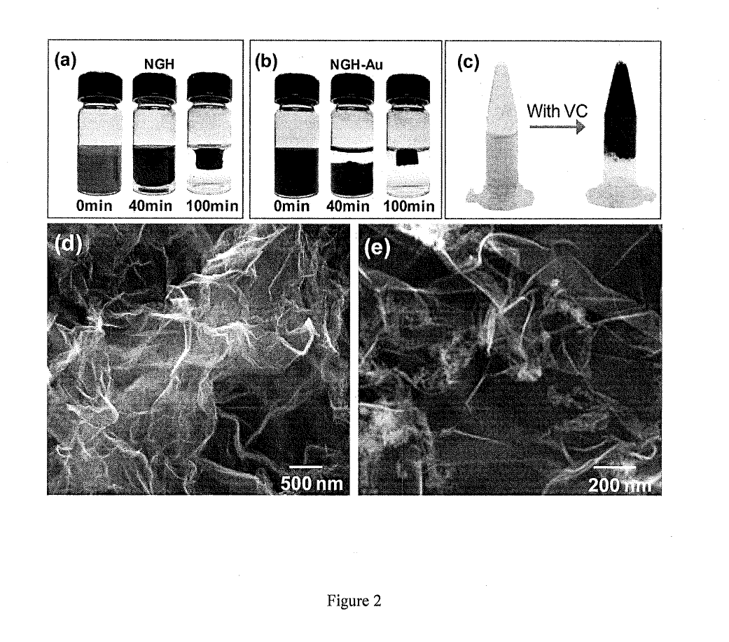

FIG. 1 illustrates the general synthetic procedures for synthesizing NGH and NGH-Au. Pre-dispersed graphite oxide (GO) sheets, VC with respective TiO₂ nanorods and Au nanoparticle loaded TiO₂ nanorods were mixed to obtain a homogeneous suspension. The suspensions were left undisturbed/unstirred at 55-90° C. in a conventional oven under atmospheric pressure for 100 min. Time-evolution studies (as shown in FIG. 2a) showed that an initial brown solution turns black after 40 min. Further reaction time of 100 min shows aggregation of the GO nanosheets and TiO₂ nanorods to form the NGH which floats at the water surface. The functional groups (—OH and —COOH) form hydrogen bonds with the VC reducing agent under appropriate conditions, and leads to the assembly of GO sheets thus forming the hydrogel.¹¹ The water in which the hydrogel is suspended is observed to be completely transparent and clear, which suggests that all the composite has self-assembled and been incorporated into the hydrogel. In FIG. 2b, the graphene and Au nanoparticle loaded TiO₂ nanorods solution turns from dark purplish to black which suggests homogeneous interfacing of the Au nanoparticle loaded TiO₂ nanorods with graphene sheets. In both cases, a distinct color change to dark grey/black solution proves the successful reduction of GO, where partial restoration of the p-network within the carbon structure has occurred.¹² Essentially, the GO has been reduced to graphene and has self-assembled into a composite hydrogel driven by the p-p stacking interaction of the graphene sheets. The photograph in FIG. 2c shows the uptake of water within the NGH which is stable even upon inversion of the vial containing gel. The 3D NGH framework consists of pores/cages that facilitate the absorption of a large amount of water. Scanning electron microscopy (SEM) images of the supercritically dried graphene hydrogel (GH) reveals numerous pores formed after physical cross-linking of graphene sheets into an interconnected network (as shown in FIG. 2d). A similar porous structure is observed for the NGH sample along with the TiO₂ nanorods (FIG. 2e). The pore sizes are in the range of sub micrometer to several micrometers while the pore walls are thin/semitransparent.

Materials Characterizations Scanning electron microscopy (SEM) characterization was carried out using a JEOL FEG JSM 6700F field-emission operating at 15 kV. X-ray photoelectron spectroscopy (XPS), VG ESCALAB 220I-XL system equipped with an Mg Kα x-ray source was employed chemical composition studies. X-ray diffraction (XRD) was carried out on a Philips X-ray diffractometer with Cu Kα radiation (λ=1.541 Å). Absorption spectra were obtained using a Shimadzu UV-3600 UV-vis spectrophotometer. Brunauer-Emmett-Teller (BET) measurements were conducted using Quantachrome Nova 1200 with N₂ as the adsorbate at liquid nitrogen temperature. Raman spectra were measured using Raman spectroscopy (Renishaw inVia Raman microscope) with VIS (488 and 633 nm) and UV (325 nm) lasers. H₂ uptake was measured using pressure-Composition Isotherm Measurement with the AMC four-channel Gas Reaction Controller (4-ch GRC). Electrochemical impedance spectroscopy (EIS) was performed using a PARSTAT 4000 from Princeton. The electrolyte used was 0.1M Na₂SO₄ in deionized water. H₂ evolution measurements were carried out using 30 mg of hydrogel and 10 ml DI water (10% methanol) contained in a quartz vial and illuminated with a 300 W Xe lamp (Excelitas, PE300BFM). The reaction mixture was purged with Ar gas for 15 min prior to measurements. The reaction mixture was syringe drawn (100 μl) to sample the gas composition using gas chromatographer (Shimadzu, GC-2014AT).

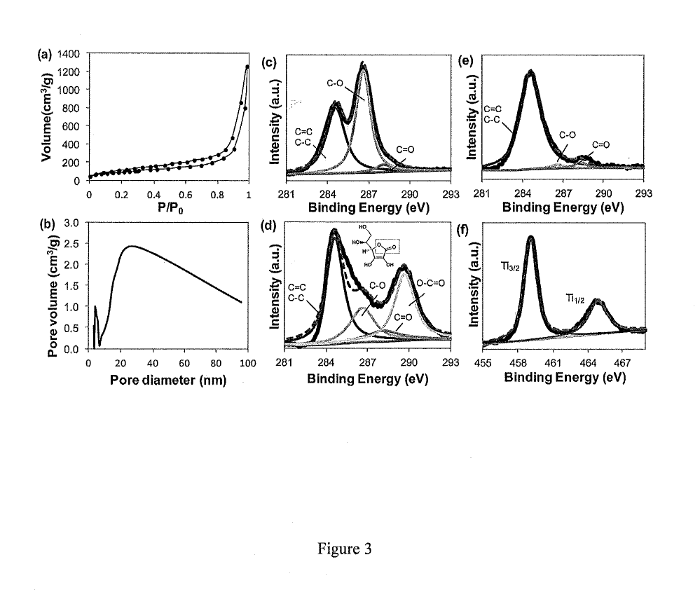

The Brunauer-Emmmett-Teller (BET) specific surface area and porous structure characteristics of the supercritically dried NGH were determined using nitrogen isothermal adsorption. FIG. 3a displays a nitrogen adsorption/desorption isotherm which exhibits an H3 hysteresis loop observed at relative pressure (P/P0) close to unity, suggesting the presence of large mesopores and macropores.¹³ The specific surface area is 327 m² g⁻¹ which is significantly higher than the reported graphene aerogel (˜117 m² g⁻¹).¹⁴ It is believed that the large specific surface area facilitates a better access and diffusion of the liquid and gaseous reactants which is beneficial for photocatalytic reactivity. However, the obtained surface area is lower compared to the graphene aerogel (˜2000 m² g⁻¹) formed by covalent carbon cross linking based on resorcinol-formaldehyde sol-gel chemistry.¹⁵ This may be due to the effect of different methods of synthesizing and processing of the materials where sonication of the GO dispersion and addition of resorcinol-formaldehyde will both result in a higher degree of GO exfoliation which then yields a higher surface area than NGH. It is noteworthy that the application of this work does not require drying of the NGH can be used directly for water splitting which reduces the cost and time needed for material processing. The pore size distribution was determined by the Barrett-Joyner-Halenda (BJH) method. FIG. 3b shows the pore volume of 1.9 cm³ g⁻¹ with the corresponding bimodal size distributions of 3.9 and 24 nm for the meso- and nanopores.

The deconvoluted C1s X-ray photoelectron spectroscopy (XPS) spectrum of the GO sample indicates the presence of various carbon bonds namely C—C (284.6 eV), C—O (286.5 eV), and CLO (288.1 eV), corresponding to sp² aromatic rings, epoxy/alkoxy, and carbonyl groups, respectively (FIG. 3c). The inset shows the chemical structure of GO. The C1s spectra of GH and NGH (FIGS. 3d and f) display similar peaks except that the peak intensities of oxygen containing functionality, predominantly the C—O peaks are of lower intensity than the GO sample. A significant decrease of the C—O peak in comparison with the original GO sample, reflects the reduction of GO to graphene. It is noted that the GH shows the presence of an additional peak at 289.7 eV which is attributed to O—CLO, also reported for another VC reduction of GO.¹⁶ The inset shows the chemical structure of VC which contains many oxygen-containing functional groups wherein the electrons in the double bond, hydroxyl group lone pair, and the carbonyl double bond form a conjugated system. The carbonyl group is responsible for the existence of the additional peak. The XPS results show that VC is an effective reducing agent; a good alternative to hydrazine which is an aggressive chemical that can potentially introduce defects into graphene. It has been shown that hydrazine reduced GO consists of covalently linked C—N species whilst VC reduced GO shows only oxygen-containing species consistent with a mild yet effective reduction reaction. It is observed that the GH is further reduced with the addition of TiO₂ nanorods via interactions with the TiO₂ surface hydroxyl groups to undergo charge transfer.18 FIG. 3f shows the NGH sample with the presence of Ti 2p_{3/2} at 459.1 eV and the Ti 2p_{1/2} at 464.4 eV due to the incorporation of TiO₂ nanorods into the GH.

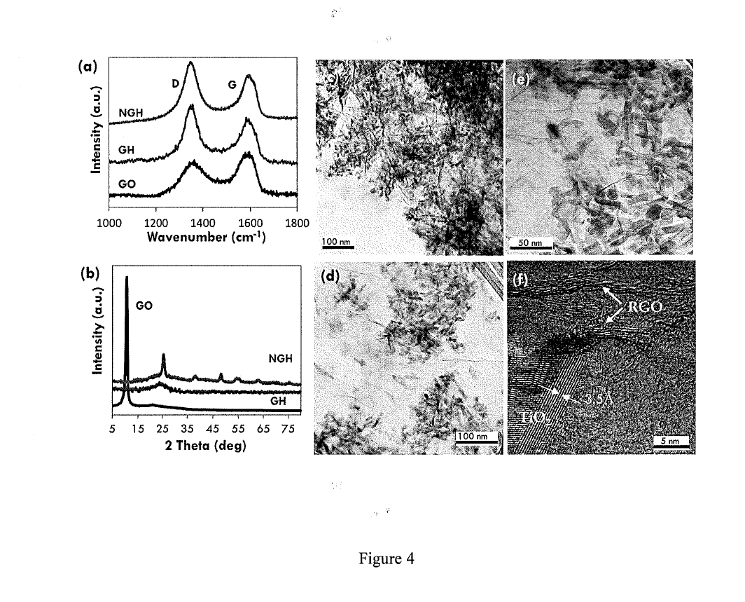

FIG. 4a shows the Raman spectrum of GO, GH, or NGH which display two characteristics peaks around 1350 and 1590 cm⁻¹, attributed to the D and G bands of carbon, respectively. The G band is related to graphitic carbon while the D band is associated with the disorder-induced structural defects of graphitic domains. The intensity ratio (I_{D}/I_{G}) of GO was determined to be 0.79, while that of GH or NGH was higher at 1.33 and 1.32 respectively, which signifies partial restoration of the disordered graphene sheets upon reduction with VC. It is noted that the Raman spectra of GH and NGH have similar peak positions and I_{D}/I_{G} which implies that the graphene supramolecular network is well-preserved even after TiO₂ nanorods integration. The successful reduction of GO using VC is further reflected with the X-ray diffraction (XRD) studies. FIG. 4b shows the XRD patterns of GO, GH and NGH. The GO has a large interlayer distance of 8.5 Å (2θ=10.4°) relative to graphite (3.36 Å) due to the presence of hydroxyl, epoxy, and carbonyl groups. The large interlayer spacing of GO weakens the van der Waals interactions between the sheets, hence exfoliation down to a few layers of graphene sheets is feasible. The transmission electron microscopy (TEM) images complement the XRD results since it has been routinely observed that the GH samples comprise of 3-6 layers of graphene sheets. The GH spectra shows a broad diffraction peak at 2θ=23.4° corresponding to a much smaller interlayer distance of 3.8 Å, which suggests a p-conjugated structure recovery upon VC reduction. The GH interplanar distance is larger than the graphite indicating the presence of residual oxygenated functional groups. Furthermore, the broad graphitic (002) plane of GH suggests a poor ordering of graphene sheets along their stacking direction since they are self-assembled into the 3D network in a random manner. As for the case of NGH, diffraction peaks due to TiO₂ anatase phase with characteristic (101), (004), (200), (105), (211), (204) planes were observed (JCPDS PDF 00-021-1272). The anatase TiO₂ (101) and graphene (002) XRD peaks are located at ˜25.4° and 23.4° which resulted in fairly indistinguishable peaks.

The activity of a catalytic system is dependent both on the surface area available for the reaction as well as on the degree of photocatalyst dispersion. GO with its extremely high surface area makes a good support for dispersion of other nanomaterials in aqueous media. The feasibility of water splitting to produce H₂ by using TiO₂ nanoparticles on 2D graphene has been reported. Here, 1D TiO₂ nanorods are employed to allow better interfacial contact and also to enhance vectorial electron transport due to decreased grain boundaries. It is observed from the TEM images that TiO₂ nanorods were homogeneously interfaced with the graphene sheets (FIGS. 4c-e). The TiO₂ nanorods have a diameter of ˜10-30 nm, with lengths of several tens of nanometers. At higher resolution (FIG. 30, it is evident that the NGH is composed of 3 to 6 layers of graphene sheets which are interfaced with TiO₂ nanorods. Strong chemical coupling between the graphene sheets and the TiO₂ nanorods is possible since H bonding or electrostatic interactions between the hydroxyl groups of TiO₂ and the functional groups of GO can be expected. The lattice fringes of the TiO₂ nanorods with a d spacing of 0.35 nm can be assigned to the (101) lattice planes of the anatase phase.

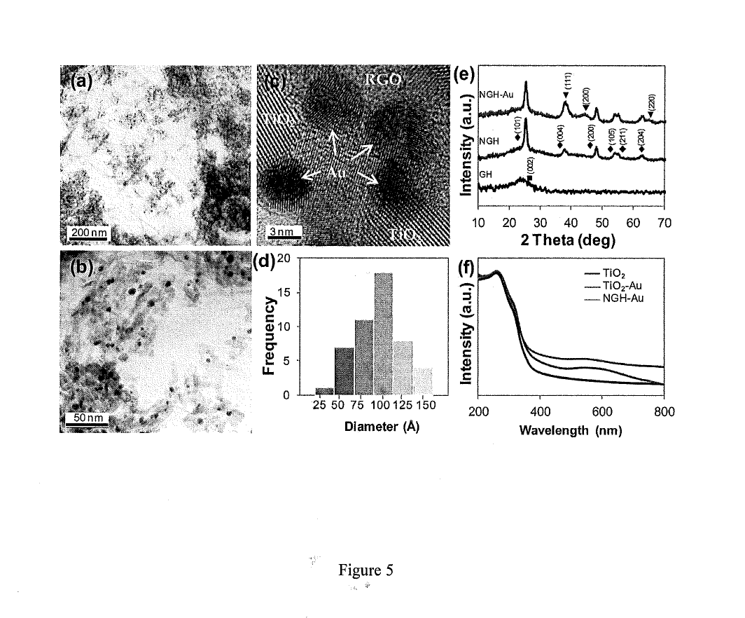

In the past few decades, a significant understanding of noble metal co-catalysts loaded onto transition metal oxide semiconductor photocatalysts has been derived mainly from Pt. It has been proven that the Pt co-catalysts decreases the H₂ evolution overpotential and suppresses the recombination rate. However, there is an increasing interest in Au/TiO₂ systems primarily in the field of heterogeneous catalytic oxidation which has recently extended to the photocatalysis field. The development of stable and durable photocatalysts requires the co-catalyst to be chemically inert, especially towards water/photo corrosion. For this reason, noble Au metal nanoparticles are used in this work. When Au nanoparticles are deposited onto the TiO₂ photocatalyst, a color change from white to dark purplish was observed (FIG. 1b). This is due to the characteristic surface plasmon of Au in a nanosized dimension which will promote a visible light photoresponse upon excitation. FIG. 5a and b show low resolution TEM images of a Au nanoparticle loaded TiO₂ nanorods hydrogel (NGH-Au). The Au nanoparticles are fairly uniformly deposited on TiO₂ nanorods without aggregation. The higher resolution TEM image (FIG. 5c) shows the lattice fringes of the Au nanoparticles, well matched to the (111) planes of Au. The geometrical distribution of the Au nanoparticles showed a size range from 2.5-15 nm, and the mean diameter was approximately 10 nm (FIG. 5d). The deposition of the reasonably small Au nanoparticles ensures a catalytically active co-catalyst. It has been shown that the Au catalytic activity is derived from its nanometric dimensions and its reactivity progressively reduces with increasing the particle size, disappearing beyond 20 nm. In addition to the tailoring of particle size and distribution, controlling other physicochemical parameters such as good interfacing with its support is equally important. An intimate interfacing of the TiO₂ nanorods, Au nanoparticles and graphene (FIG. 5c) will ensure favorable separation of photogenerated carriers and enhancement of the photocatalytic performance.

The XRD patterns of GH, NGH and NGH-Au are shown in FIG. 5e. It is noted that both the NGH and NGH-Au have broad background peaks between 20 to 35°, which are due to the overlapped (002) graphene at 23.4° and anatase (101) TiO₂ at 25.4°. In comparison, the NGH-Au spectrum has addition diffraction peaks at 38.1°, 44.3° and 64.5° which correspond to the (111), (200) and (220) face-centered cubic Au nanoparticles (JCPDS 4-0783). FIG. 5f shows the optical absorption spectra of the pure TiO₂ nanorods, Au nanoparticle loaded TiO₂ nanorods and NGH samples taken at room temperature in the range of 200-800 nm. The absorbance in the visible light region is seen with the addition of Au nanoparticles. The visible absorption band at ˜575 nm has been attributed to the surface plasmon band and arises from the collective oscillations of confined valence electrons. The absorption wavelength and the shape of the surface plasmon band depends on many factors including the dielectric constant of the medium, nanoparticles geometrical shape and size, and coulombic charge of the nanoparticles amongst others. Similarly, the graphene composites display a broad background absorption in the visible-light region which is supported by the color change from white to grey. The addition of Au nanoparticles and graphene into the photocatalyst is observed to increase the light absorption intensity and range, which is beneficial for photocatalytic performance.

Proof-of-concept photocatalytic H₂ production based on the 3D NGH was carried out. As mentioned, the wide bandgap of TiO₂ (ca. 3.0-3.2 eV) limits photocatalytic H₂ production activities, due to the UV component of the solar spectrum accounting for less than 4%. One of the ways to enhance the photocatalytic performance of TiO₂ is to extend the light absorption to the visible region. There are two ways to go about it; band gap engineering via doping and sensitization. In the present invention, the latter approach was adopted, that is to sensitize the TiO₂ with graphene and the Au metal nanoparticles. Sensitization of TiO₂ with graphene and Au nanoparticles via surface modifications has the advantage over doping processes as it does not introduce any recombination centres to the crystal lattice. Besides that, graphene and noble metal nanoparticles are stable materials and are less susceptible to photodegradation during the catalytic reaction. The photocatalytic H₂ production activities of various samples were evaluated under xenon arc lamp (with and without cut-off filter, λ=420 nm) irradiation in the presence of methanol as a hole scavenger.

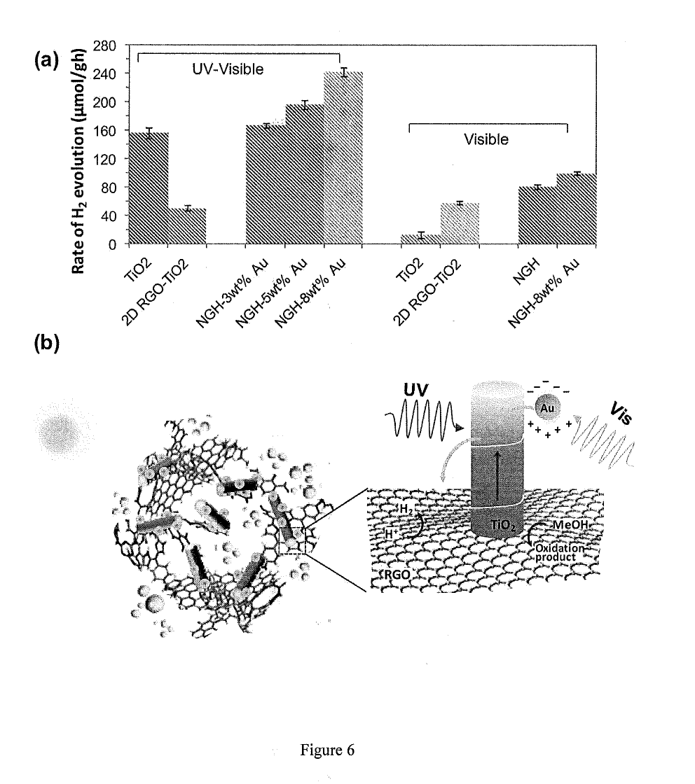

Photocatalysis measurements of control samples, namely pure TiO₂ nanorods and 2D reduced graphene sheets-TiO₂ composite (2D RGO-TiO2) and NGH with different wt % loading of Au nanoparticles under different light wavelength irradiations were carried out (FIG. 6a). Under UV-visible irradiation, the TiO₂ nanorods and 2D RGO-TiO2 show ˜156 and 51 mmol h⁻¹ g⁻¹ of H₂ being produced respectively. 2D RGO-TiO₂ experiences light shielding of TiO₂ by graphene resulting in low H₂ production due to the incorporation of TiO₂ nanorods between tightly packed/stacked 2D graphene sheets. In contrast, by incorporating TiO₂ nanorods into a 3D graphene with interconnected network pores, the photocatalytic activity is observed to increase to ˜167-242 mmol h⁻¹ g⁻¹. The H₂ production increases with the Au nanoparticles loading up to 8 wt %. Furthermore, the photoresponse of the pure TiO₂ nanorods, 2D RGO-TiO₂, NGH and NGH-Au were studied under visible light irradiation. Under visible irradiation, the production of H₂ increased with 2D RGO-TiO₂, NGH and NGH-Au (8 wt % loading) samples as such photocatalytic reactivities under visible light are much more efficient than the TiO₂ nanorods.

FIG. 6b is a schematic representation of the hydrogel composites; namely graphene network functionalize/sensitizes with semiconductor photocatalyst, carbon quantum dots and/or co-catalyst nanoparticles to enable upconversion UV-Vis-NIR light absorption for photocatalytic concurrent H₂ production and storage. As illustrated in FIG. 6b, upon visible light irradiation, electrons from the Au nanoparticles are injected into the TiO₂ conduction band leading to the generation of holes in the Au nanoparticles and electrons in the TiO₂ conduction band. The holes are quenched by sacrificial electron donors. The electron injection from Au to TiO₂ is based on LSPR excitation which has been demonstrated and proven in other Au/TiO₂ work as well as other material systems, Au/ZnO and Ag/TiO₂. Essentially, the incident photons are absorbed by ˜10 nm Au nanoparticles through LSPR excitation which effectively injects electrons from the Au nanoparticles into the conduction band of TiO₂. One possible explanation is that the intense optical near-field collective oscillation of electrons on the SPR excitation leads to interband excitation from the d bands to the sp conduction band. This promotes electrons transfer from Au to TiO₂ after overcoming the Schottky barrier at their interface and results in charge separation in the Au/TiO₂ photocatalyst. In addition, upon UV-vis irradiation, TiO₂ absorbs photons of energy greater than the band gap which generates electron-hole pairs. All the excited electrons are in turn transferred from the TiO₂ conduction band to the graphene active sites to produce protons in the solution to generate H₂. This is highly anticipated since the potential of RGO is lower than the conduction band of anatase TiO₂, thus all photoinduced electrons can be transferred to the graphene leading to effective electron-hole separation. The graphene network acts as an effective charge separator so it facilitates interfacial charge transfer along the graphene sheets which can be derived from EIS results.

### H₂ Adsorption of NGH

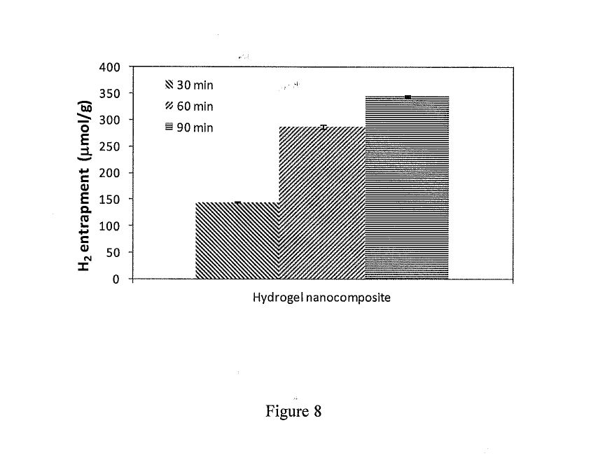

FIG. 8 shows hydrogel composite were irradiated with Xenon lamp for 2 h before removing them from the lamp. This is followed by mechanically agitation in a conventional ultrasonic bath for duration of 90 min at ambient temperature and pressure while produced H₂ which were trapped-released was intermittently measured using gas chromatography at 30, 60 and 90 min Architecturing a 3D interconnected framework (hydrogel) forms desirable pores that facilitate adsorption of H₂.

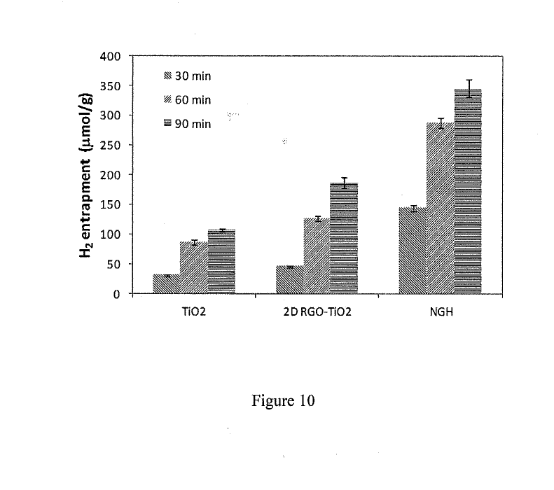

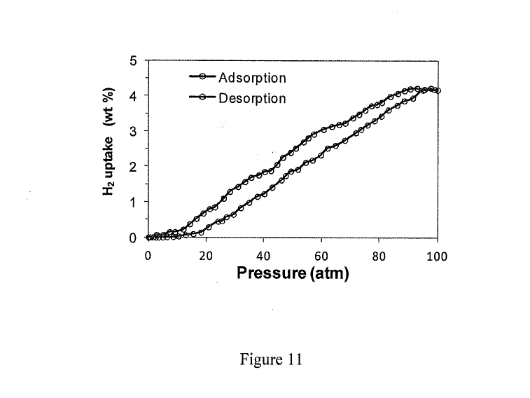

Another study on H₂ adsorption in the various samples; pure TiO₂, 2D RGO-TiO₂ and 3D NGH were carried out. The samples were irradiated with a xenon lamp for 2 h before removing them from the lamp. This is followed by mechanical agitation in a conventional ultrasonic bath for 90 min while H₂ that was trapped and released was intermittently measured at 30, 60 and 90 min as shown in FIG. 10. It is noted that the pure TiO₂ and 2D RGO-TiO₂ show lower H₂ content as compared to the 3D NGH. Forming a 3D interconnected framework (hydrogel) creates desirable pores which facilitate the adsorption of H₂. Furthermore, a pressure-composition isotherm of NGH at room temperature and a pressure range of 0 to 100 atm was carried out to affirm H₂ adsorption of the NGH (FIG. 11). It is postulated that after the initial 2 h of light irradiation some of the H₂ molecules diffuse through the aqueous phase and emerge as a gas as measured in FIG. 6a; the remaining H₂ is trapped within the NGH. Hence during the mechanical agitation, the graphene sheets are buckled to release the trapped H₂ gas within the pores as well as between the interlayered graphene sheets. It has been theoretically predicted that graphene sheets exhibits fast kinetic (quick H₂ uptake and release) characteristics and that buckling of graphene sheets can easily release trapped H₂.

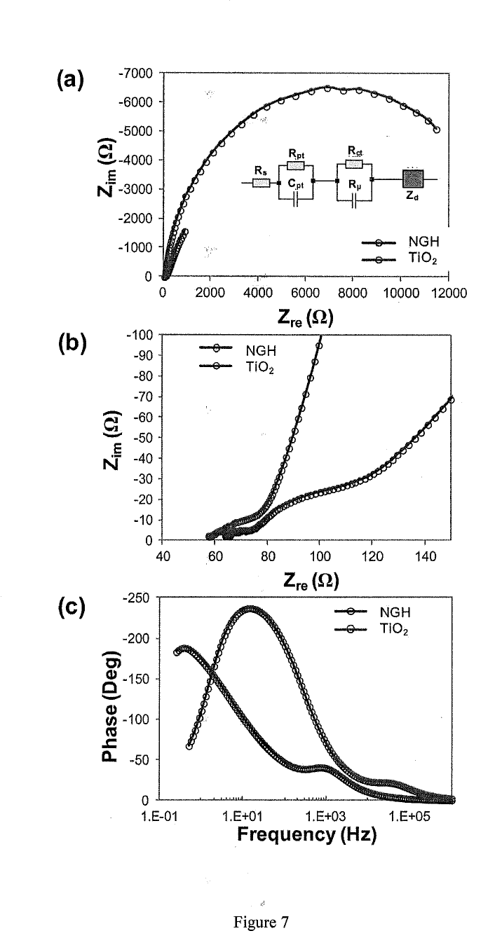

The Nyquist plots of the NGH and TiO₂ nanorods films are shown in FIGS. 7a and b. R_{ct} of NGH is ˜3.51 kΩ, which is smaller than for the TiO₂ nanorods ˜11.82 kΩ indicating a better electron conductivity between the NGH electrode and electrolyte.³⁹ Furthermore, the time constant can be determined using the following relation:

τn=Rct×Cμ

where τn relates to electron lifetime, Cμ the chemical capacitance and Rct is the charge transfer resistance between the electrodes and the electrolyte interface. The NGH electrode shows a higher τπ of 2.06 s as compared to the TiO₂ nanorods (0.11 s) which implies a longer electron lifetime. Also, the characteristic frequency peaks on the Bode phase plots show the peak for the TiO₂ nanorods is at a higher frequency than the NGH (FIG. 7c). The characteristic frequency peaks are inversely related to the electron lifetime, which suggests that the electrons take a longer time to recombine in the NGH film as compared to the TiO₂ nanorods film.

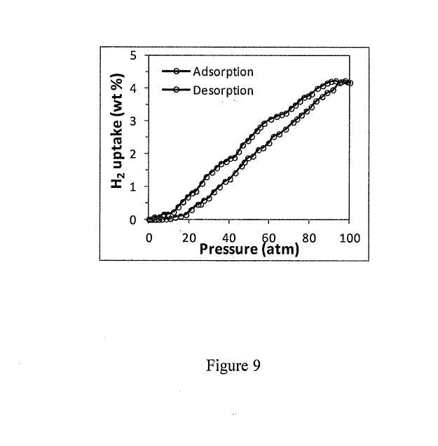

FIG. 9 shows the pressure-composition isotherm of hydrogel composite at room temperature and pressure range of 0 to 100 atm. The H₂ adsorption of hydrogel composite was around 2.5 and 4.2 wt % at pressure of 50 and 100 atm respectively. The adsorption capacity of hydrogel composite at room temperature is comparable to GO-MWCNTS composite (2.6 wt %) and surpasses many other metal-organic frameworks (MOFs) and carbon based materials. However, it was found that not all adsorbed H₂ desorbed when the samples were evacuated. The presence of hysteresis is possibly due to the trapping of adsorbed H₂ molecules in small cavities or mesopores such as interlayer graphene sheets (˜3.8 \acute{Å}). It has been experimentally shown and calculated (first-principles calculations) that interlayer distance of 6.5\acute{Å}plays an important role as an optimum spacer between the graphene sheets for maximum H₂ uptake. In our case, the kinetics of H₂ uptake is determined not only by the H₂ molecules diffusing through the porous network of graphene hydrogel but also through the lamellar interlayer graphene sheets. In general, high micropore volume and surface area are essential parameters for consideration of superior H₂ storage capacity which is well-taken into account in our architectured hydrogel composite as it offers a more direct diffusion pathway and greater access to internal surfaces.

### Sonocatalysis H₂ Production of NGH

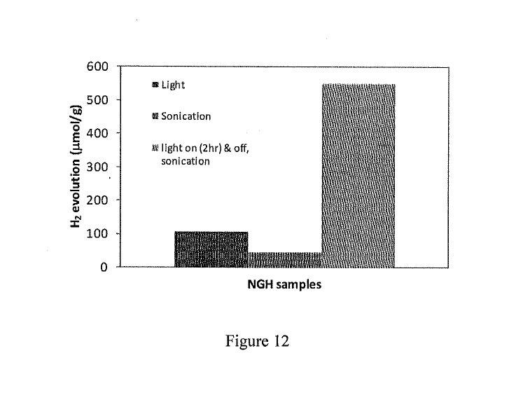

It can be observed that purely mechanically agitated photocatalyst show low H₂ production (as shown in FIG. 12). The use of ultrasound for photocatalytic reaction (sonocatalysis) has been reported to produce H₂ as it promotes catalytic activity due to surface cleaning, particle size reduction and enhanced mass transport.

### CONCLUSION

In recent years, independent research efforts have been made to design and discover nanostructured materials that either generates or stores H₂. So far, no practical material has been proposed and developed for these dual purposes. In this work, we developed a self-contained H₂ generator and storage media, supramolecular hydrogel composite based on green chemistry, employing vitamin c as the reducing agent. By physical and chemical cross-linking of graphene sheets and functionalizing with semiconductor photocatalyst and upconversion carbon dots to attain a three-dimensional (3D) liquid and gas entrapment network, direct water splitting and H₂ uptake are made possible.

Compared to lanthanide upconverter, the carbon quantum dots (QDs) are promising alternatives since carbon based materials are known to possess superior thermal/chemical stability, abundant, cheap and non-toxic nature. Also, carbon-based materials can be easily functionalized with organic molecules and hybridized with inorganic nanomaterials via covalent bonding, to enhance their upconversion luminescence performances through the synergistic effect. Finally, carbon QDs, the quasi-spherical particles possess strong quantum confinement, edge effects and many unexplored explicit structural and chemical properties which are expected to induce unique upconversion luminescence phenomena.

Buckling the graphene sheets under mechanical agitation releases the trapped-adsorbed H₂ molecules as needed and at near room temperature/pressure as one can get. From the perspective of H₂ generation and storage, the critical attributes of light weight, solution processable, molecular H₂ sorbents in a self-contained media can potential overcome the key challenges of producing and storing of H₂ on demand and on board applications.

The present invention demonstrates a facile solution processable method of using VC as reducing agent for the synthesis of a 3D NGH. By forming a 3D framework of NGH, we are able to create desirable pores that facilitate water absorption, an open structure for the integration of functional TiO₂ nanorods and Au nanoparticles for charge generation and collection via interconnected highly conductive electrical pathways. Moreover, sensitization of the TiO₂ nanorods with Au nanoparticles and graphene, has allowed the utilization of the solar spectrum beyond the UV wavelength. This is important since photocatalytic materials with a visible light response are required for efficient solar energy utilization. For the first time, it is shown that NGH is a promising self-contained media for H₂ production and adsorption.

Whilst there has been described in the foregoing description preferred embodiments of the present invention, it will be understood by those skilled in the technology concerned that many variations or modifications in details of design or construction may be made without departing from the present invention.

1. A method for producing a hydrogel composition for photocatalytic hydrogen production and storage, the method comprising:
(a) providing TiO₂ nanorods and loading carbon quantum dots onto the TiO₂ nanorods to form a first mixture;
(b) providing a second mixture of dispersed graphene oxide;
(c) mixing the first and second mixture by ultrasonic dispersion to form a third mixture; and
(d) adding a reducing agent to the third mixture to form the hydrogel composition that defines a three-dimensional porous and continuous cross-linked structure.

2. The method according to claim 1, wherein the carbon dots are chemically coupled onto the surface of TiO₂.

3. The method according to claim 1, wherein the reducing agent is vitamin C.

4. The method according to claim 3, wherein the 0.25 g of vitamin C is added to the third mixture.

5. The method according to claim 1, wherein the dispersed graphene oxide is prepared by a modified Hummers method.

6. The method according to claim 1, wherein the solvent for dispersing the graphene oxide is any one selected from the group: ethanol, isopropyl alcohol, and dimethylformamide.

7. The method according to claim 1, wherein a metal nanoparticle is added to the first mixture, the metal nanoparticle is any one selected from the group: gold, platinum, rhodium, palladium and any noble metal.

8. The method according to claim 7, wherein the gold nanoparticle is 10 nm in size.

9. The method according to claim 1, wherein the carbon quantum dots are prepared from ammonium bicarbonate and sodium citrate.

10. The method according to claim 1, wherein the reducing step in (d) is carried out at 90° C. for 90 to 240 minutes.

11. The method according to claim 1, wherein the TiO₂ is in anatase powder form.

12. The method according to claim 11, wherein the TiO₂ nanorods are prepared by mixing TiO₂ anatase powder with NaOH and stirring the mixture for 1 hour followed by heating the mixture at 110° C. for 48 hours to form a precipitate.

13. The method according to claim 12, wherein the precipitate is mixed with HCl, stirred for 24 hours and rinsed dried.

14. A hydrogel composition for photocatalytic hydrogen production and storage, the composition comprising:
(a) a graphene;
(b) a TiO₂ nanotube array; and
(c) a carbon quantum dot,
wherein the hydrogel composition defines a three-dimensional porous and continuous cross-linked structure.

15. The hydrogel composition according to claim 14, wherein the carbon dot is prepared by the decomposition of vitamin C.

16. The hydrogel composition according to claim 14, wherein the amounts of graphene, TiO₂, and carbon quantum dot present in the composition are 2 mg, 30 mg and 0.66 mg respectively.

17. The hydrogel composition according to claim 14, further comprising a metal nanoparticle selected from the group: gold, platinum, rhodium, palladium and any noble metal.

18. The hydrogel composition according to claim 17, wherein the gold nanoparticle is 10 nm in size.

19. The hydrogel composition according to claim 14, wherein the surface of the graphene is modified.

20. The hydrogel composition according to claim 14, wherein the surface area of the graphene is about 400 m²/g.

21. The hydrogel composition according to claim 14, wherein the porosity of the hydrogel is about 1.9 cm³/g.

22. The hydrogel composition according to claim 14, wherein the pores have a bimodal size distributions of 3.9 and 24 nm.

23. An electrode, capacitor, fuel cell, solar cell, sensor, battery comprising a hydrogel composition according to claim 14.
